(19) United States
(12) Patent Application Publication
(10) Pub. No.: US 2017/0329516 A1
(43) Pub. Date: Nov. 16, 2017

(54) SYSTEM AND A METHOD FOR CONFIGURING PROGRAMMED ICONS IN A TOUCH SCREEN DISPLAY FOR OPERATING A SERVER

(71) Applicant: Mamtha Anantharaman, Duluth, GA (US)

(72) Inventor: Mamtha Anantharaman, Duluth, GA (US)

(21) Appl. No.: 15/595,723

(22) Filed: May 15, 2017

Related U.S. Application Data
(60) Provisional application No. 62/337,215, filed on May 16, 2016.

(51) Int. Cl. G06F 3/0488; G06F 3/023; G06F 3/0482; G07G 1/00; G06F 9/30; G06Q 10/08

(52) U.S. Cl. CPC G06F 3/04886; G07G 1/0081; G06F 9/30; G06F 3/0238; G06F 3/0482; G06Q 10/087

(57) ABSTRACT

Disclosed is a digital keyboard system for allowing a user to send instructions over a communication network. The digital keyboard system includes a memory unit, a processing unit, and a display unit. The memory unit stores plurality of modules. The processing unit is coupled to the memory unit to process the stored plurality of modules. The display unit displays the processed plurality of modules. The plurality of modules includes pre-programmed keys module, a position tab module, a digital keyboard module, and a communication module. The pre-programmed keys module displays pre-programmed keys and further allowing the user to select at least one of the pre-programmed keys. The position tab module is coupled to the pre-programmed keys module for displaying plurality of position tabs as arranged in a keyboard. The user replaces any position tab with any pre-programmed key to create a configuration. The digital keyboard module displays only the configured pre-programmed keys at the same position where the user replaces the position tabs with the pre-programmed keys, further the digital keyboard module allows the user to input instructions corresponding to the pre-programmed keys. The communication module is coupled to the digital keyboard module for sending the received input instructions over the communication network. The digital keyboard system is used to communicate with a scanner to receive product details and further sends the information related to the product details over the communication network.

### CROSS REFERENCE TO RELATED APPLICATION

This application claims priority of U.S. application Ser. No. 62/337,215 filed on May 16, 2016 which is incorporated by reference herein in its entirety.

### BACKGROUND OF THE INVENTION

### 1. Field of the Invention

The present invention generally relates to a system and a method relates to a virtual keyboard; and more particularly relates to a method and a system for configuring programmed icons in a virtual keyboard for operating a server.

### 2. Description of Related Art

Currently, in the supermarket chains, in retail, in distribution centers, in logistics processes, as well as in manufacturing plants, there is a need to enter product information to record in the server. In existing data entry ways people generally enter the data manually. Most of the existing input keyboards or touch screen keys have small keys.

The keys are too small, so they are not comfortable to use in the scenario the users are operating under today, which requires high speed scanning and high speed data entry. Even if users try to operate, they are very difficult to operate because the keys are crowded, if the user really wants to press “W”, one might accidentally press “E” and enter the wrong key and execute a wrong function, and thereby increasing the process execution time and the operational cost.

Other available technologies use physical push buttons. It takes long time for young users to learn and get used to this technology. In the push button keys scenario, users will have to multi-tap, for example press a “Fn”—Function key before pressing a specific function key, users must press a blue color key to get the blue color functions working, or will have to press an orange color key to get the orange color functions working, so it is multi-tapping and takes a long time to learn and get used to.

Therefore, there is a need of a digital keyboard system for configuring pre-programmed keys for operating a server. Further, the system should display only the desired pre-programmed keys in comfortable sizes. Furthermore, the system should also incorporate heuristics that counts the most pressed keys and shows only those keys that are most used by the user.

### SUMMARY OF THE INVENTION

In accordance with teachings of the present invention, a digital keyboard system for allowing a user to send instructions over a communication network is disclosed.

An object of the present invention is to provide a digital keyboard system with a memory unit for storing plurality of modules, a processing unit is coupled with the memory unit to process the stored plurality of modules, a display unit displays the processed plurality of modules. The plurality of modules includes a pre-programmed keys module, a position tab module, a digital keyboard module and a communication module.

The pre-programmed keys module displays pre-programmed keys. The user selects at least one of the pre-programmed keys. The position tab module is coupled to the pre-programmed keys module displays plurality of position tabs as arranged in a keyboard. The user replaces any position tab with any pre-programmed key to create a configuration.

The digital keyboard module displays only the configured pre-programmed keys at the same position. The user replaces the position tabs with the pre-programmed keys. The digital keyboard module allows the user to input instructions corresponding to the pre-programmed keys. The communication module is coupled to the digital keyboard module for sending the received input instructions over the communication network.

Another object of the present invention is to provide the digital keyboard system wherein the pre-programmed keys of the pre-programmed keys module are arranged in a scroll bar. The user scrolls the scroll bar to access the pre-programmed keys. The scroll bar is scrollable in both forward and backward directions.

Another object of the present invention is to provide a digital keyboard system communicating with a scanner to receive product details. The digital keyboard system allows a user to send instructions over a communication network. The digital keyboard system includes a memory unit, a processing unit, a bi-directional communication unit and a display unit.

The bi-directional communication unit receives product details from the scanner. The digital keyboard module allows the user to input instructions corresponding to the pre-programmed keys. The plurality of modules includes an inventory management module to display product details received from the scanner. The inventory management module further receives the input instructions corresponding to the product details from the digital keyboard module.

The communication module coupled to the digital keyboard module for sending the product details as the input instructions through the bi-directional communication unit over the communication network. Further, the digital keyboard system includes an image module for displaying a product image corresponding to the scanned product number. The digital keyboard module and the product details are superimposed on the product image.

Another object of the present invention is to provide the digital keyboard system with my keys module to display the configured pre-programmed keys in the digital keyboard module. Further, the digital keyboard system include a heuristic module coupled to the digital keyboard module to maintain a count of key presses and thereafter automatically configures pre-programmed keys module by optimally displaying the most often used keys.

Another object of the present invention is to provide the digital keyboard system with a cursor module to display a cursor to select pre-programmed keys from the pre-programmed keys and further the cursor allows the user to replace the position tabs with the pre-programmed keys.

Another object of the present invention is to provide the digital keyboard system with an enter module coupled to the digital keyboard module for allowing the user to send the input instructions over the communication network. Further, the digital keyboard system includes an enter module coupled to the digital keyboard module for allowing the user to send the input instructions over the communication network.

Another object of the present invention is to provide the digital keyboard system with a next module to move the cursor in a pre-determined position in the horizontal direction. Further, the digital keyboard system includes an alpha module coupled to the pre-programmed keys to open alphabet pre-programmed keys.

Another object of the present invention is to provide the digital keyboard system with a profile module to allow the user to store plurality of digital keyboard module, wherein each digital keyboard module contains a different set of pre-programmed keys.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a block diagram of a digital keyboard system for allowing a user to send instructions over a communication network in accordance with a preferred embodiment of the present invention;

FIG. 2 illustrates a block diagram of a digital keyboard system communicating with a scanner to receive product details in accordance with another preferred embodiment of the present invention;

FIG. 3 illustrates a screenshot showing of a pre-programmed keys module and a position tab module in accordance with an exemplary embodiment of the present invention;

FIG. 4 illustrates a screenshot showing of replacement of position tabs of the position tab module with the pre-programmed keys of the pre-programmed keys module in accordance with an exemplary embodiment of the present invention;

FIG. 5 illustrates a screenshot showing of a digital keyboard module, an inventory management module and the communication module; and

FIG. 6 illustrates a screenshot showing of a dashboard module to display product details and peripheral plurality of modules in accordance with a preferred embodiment of the present invention.

### DETAILED DESCRIPTION OF DRAWINGS

The following detailed description is directed to certain specific embodiments of the invention. However, the invention can be embodied in a multitude of different ways as defined and covered by the claims and their equivalents. In this description, reference is made to the drawings wherein like parts are designated with like numerals throughout. Unless otherwise noted in this specification or in the claims, all of the terms used in the specification and the claims will have the meanings normally ascribed to these terms by workers in the art.

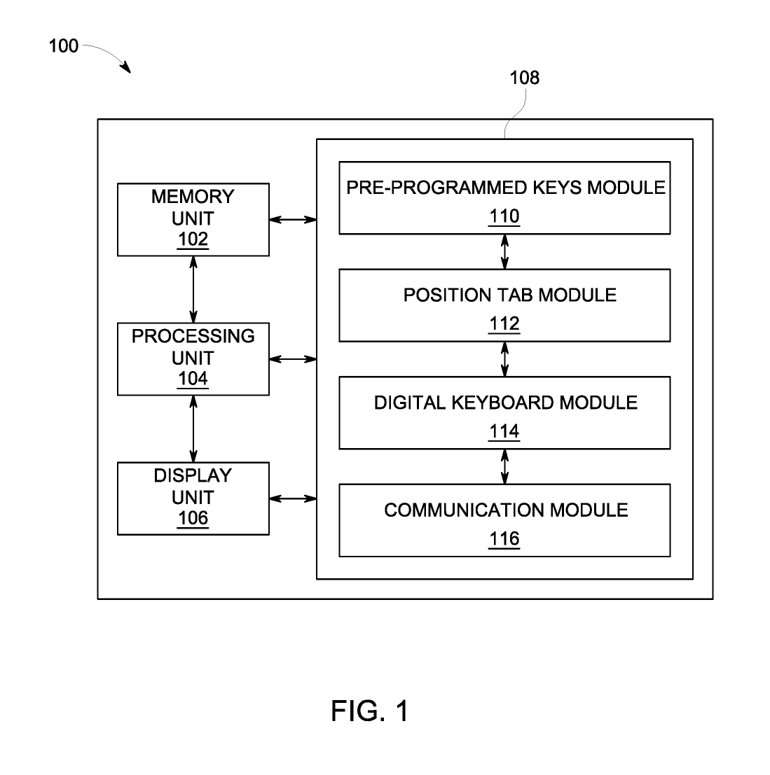

FIG. 1 illustrates a block diagram of a digital keyboard system 100 for allowing a user to send instructions over a communication network in accordance with a preferred embodiment of the present invention. The digital keyboard system 100 includes a memory unit 102, a processing unit 104, and a display unit 106.

The memory unit 102 stores plurality of modules 108. The processing unit 104 is coupled to the memory unit 102 to process the stored plurality of modules 108. The display unit 106 displays the processed plurality of modules 108. The plurality of modules includes a pre-programmed keys module 110, a position tab module 112, a digital keyboard module 114 and a communication module 116.

The pre-programmed keys module 110 displays pre-programmed keys. The user then selects at least one of the pre-programmed keys. The position tab module 112 is coupled to the pre-programmed keys module 110 displays plurality of position tabs as arranged in a keyboard. The user replaces any position tab with any pre-programmed key to create a configuration.

The digital keyboard module 114 displays only the configured pre-programmed keys at the same position where the user replaces the position tabs with the pre-programmed keys. The digital keyboard module 114 allows the user to input instructions corresponding to the pre-programmed keys. The communication module 116 is coupled to the digital keyboard module 114 for sending the received input instructions over the communication network.

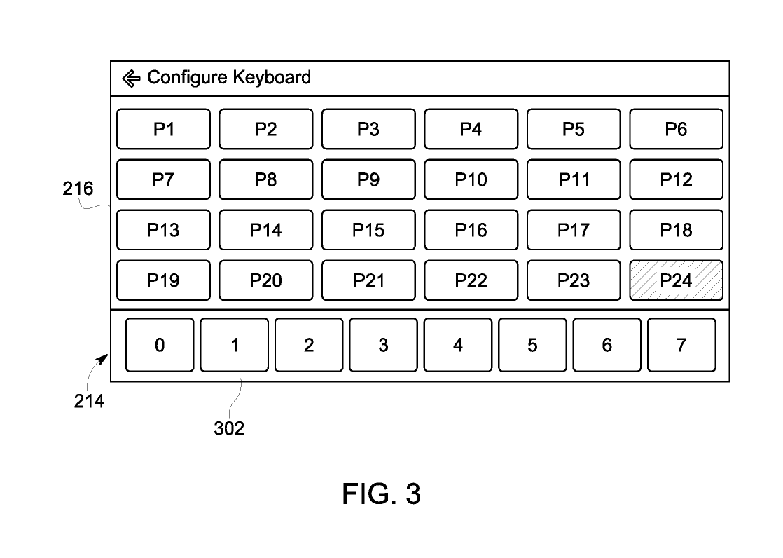

In another preferred embodiment of the present invention, the digital keyboard system includes pre-programmed keys of the pre-programmed keys module are arranged in a scroll bar. The user scrolls the scroll bar to access the pre-programmed keys. The digital keyboard system 100 is explained in detail in conjunction with FIG. 3 to FIG. 6 of the present invention.

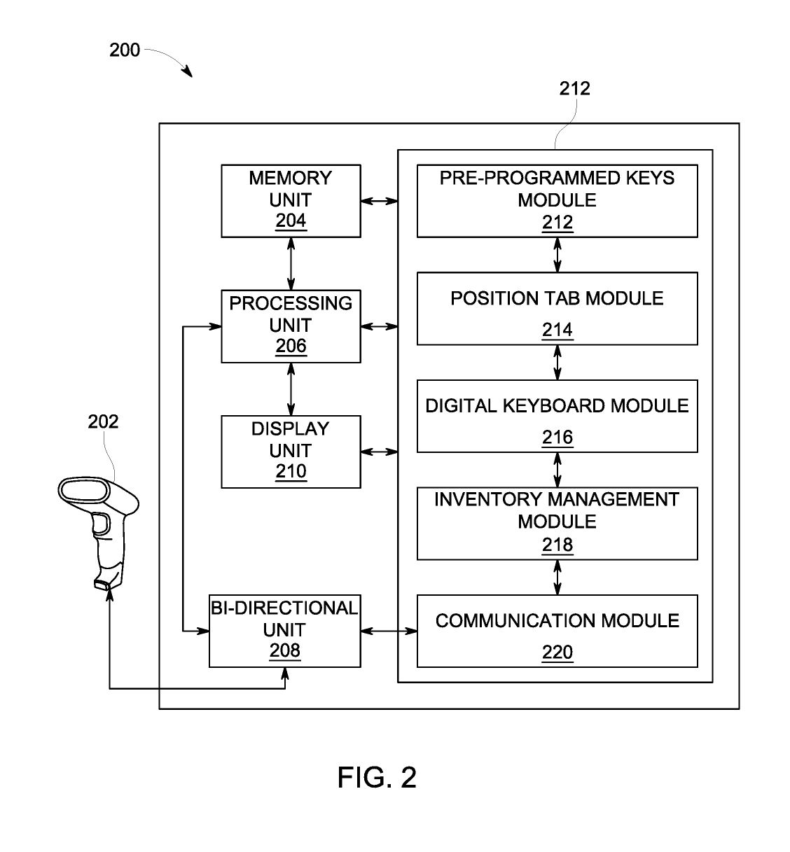

FIG. 2 illustrates a block diagram of a digital keyboard system 200 communicating with a scanner 202 to receive product details in accordance with another preferred embodiment of the present invention. The digital keyboard system 200 includes a memory unit 204, a processing unit 206, a bi-directional communication unit 208, and a display unit 210.

The memory unit 204 stores plurality of modules 212. The plurality of modules 212 includes a pre-programmed keys module 214, a position tab module 216, a digital keyboard module 218, an inventory management module 220, and a communication module. The pre-programmed keys module 214 displays pre-programmed keys. The user selects at least one of the pre-programmed keys.

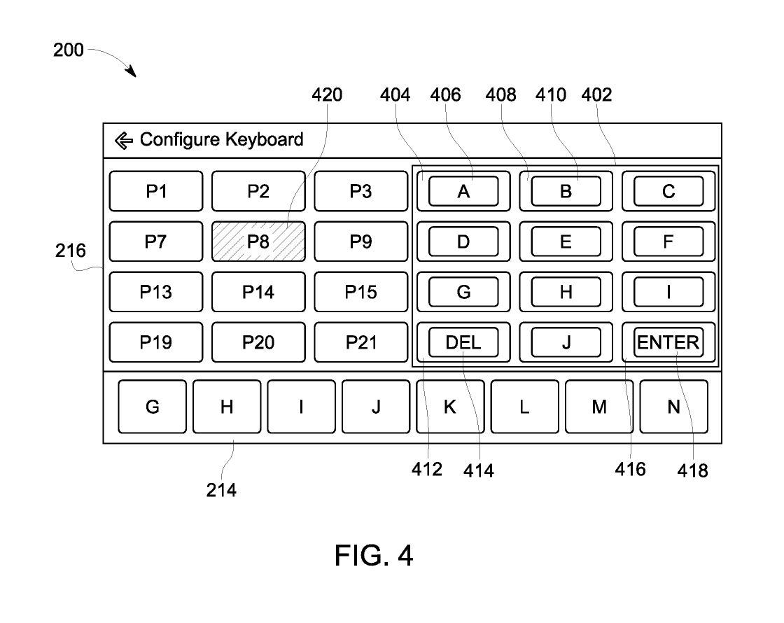

The position tab module 216 is coupled to the pre-programmed keys module 214 displays plurality of position tabs as arranged in a keyboard. The user replaces any position tab with any pre-programmed key to create a configuration. The pre-programmed keys module 212 and the position tab module 214 are explained in detail in conjunction with FIG. 3 and FIG. 4 of the present invention.

The digital keyboard module 216 displays only the configured pre-programmed keys at the same position where the user replaces the position tabs with the pre-programmed keys. The digital keyboard module 216 allows the user to input instructions corresponding to the pre-programmed keys.

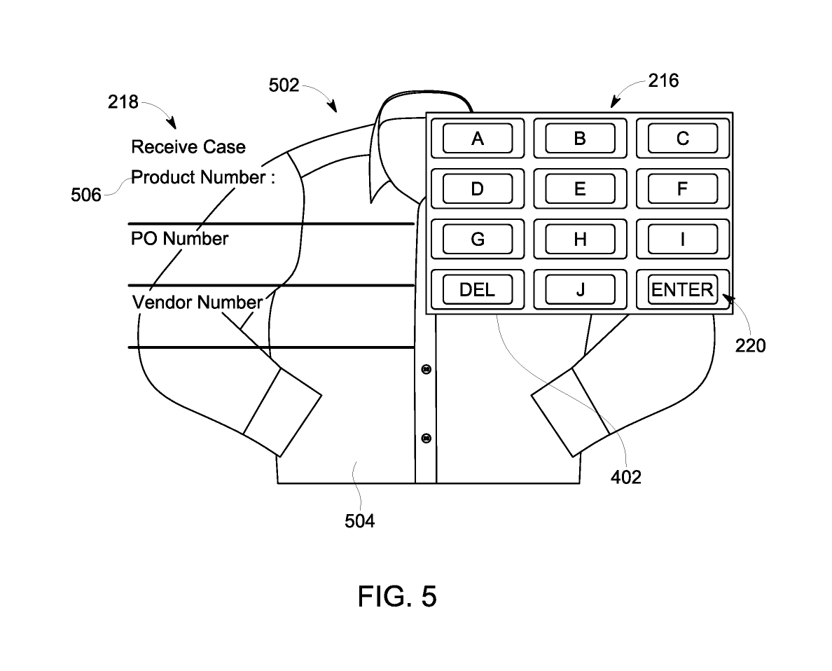

The inventory management module 218 displays product details received from the scanner 202. The inventory management module 218 further receives the input instructions corresponding to the product details from the digital keyboard module 216. The digital keyboard module 216 and the inventory management module 218 are explained in detailed in conjunction with FIG. 5 of the present invention.

The communication module 220 coupled to the digital keyboard module 216 for sending the product details as the input instructions through the bi-directional communication unit 208 over the communication network. The communication module 220 is explained in detailed in conjunction with FIG. 5 of the present invention.

Examples of the memory unit 204 include but not limited to random access memory (RAM), read only memory (ROM), flash memory, cache memory etc. Examples of the processing unit 206 include but not limited to microcontroller, microprocessor, central processing unit (CPU), graphical processing unit (GPU), digital signal processor (DSP) etc.

Examples of bi-directional communication unit 208 include but not limited to Bluetooth, LAN, WAN, wi-fi, internet enabled devices etc. Examples of the display unit 210 include but not limited to LED, LCD, OLED, any other touch screen display unit 210 etc. Examples of communication network includes but Bluetooth, LAN, WAN, wi-fi, internet etc. Examples of scanner 202 include but not limited to barcode scanner, QR scanner, QR code, digital Imager, Laser scanner, Bluetooth scanner, wired scanner etc.

FIG. 3 illustrates a screenshot showing of a pre-programmed keys module 214 and a position tab module 216 in accordance with an exemplary embodiment of the present invention. In a preferred embodiment of the present invention, the pre-programmed keys are arranged in a scroll bar 302, and the user scrolls the scroll bar 302 to access the pre-programmed keys.

Example of pre-programmed keys includes but not limited to icons, numerals, alphabets, functions, special characters, macros, images etc. In a preferred embodiment as shown in FIG. 3, the pre-programmed keys are numerals 0,1,2,3,4,5,6, and 7. Further, the position tab module 216 displays plurality of position tabs. For exemplary purposes as shown in FIG. 3, the position tabs are 24 indicated as P1, P2, P3 . . . P24.

It would be readily apparent to those skilled in the art that various numbers of position tabs and various types of pre-programmed keys may be envisioned without deviating from the scope of the present invention. With reference to FIG. 1, the pre-programmed keys module (110 shown in FIG. 1) and the position tab module (112 shown in FIG. 1) performs similar function as of the pre-programmed keys module 214 and the position tab module 216 respectively.

FIG. 4 illustrates a screenshot showing of replacement of position tabs of the position tab module 216 with the pre-programmed keys of the pre-programmed keys module 214 in accordance with an exemplary embodiment of the present invention. The user is able to replace the pre-programmed keys with the position tabs to create a configuration 402. The position tabs are arranged as in a keyboard.

For exemplary purposes, the user replaces position tab P4 404 with pre-programmed key A 406, position tab P5 408 with pre-programmed key B 410, position tab P22 412 with pre-programmed key DEL 414, position tab P24 416 with pre-programmed key ENTER 418.

It would be readily apparent to those skilled in the art that any of the position tabs may be replaced with any of the pre-programmed key without deviating from the scope of the present invention. In another preferred embodiment of the present invention, the digital keyboard system 200 includes a cursor module to display a cursor 420 to select pre-programmed keys from the pre-programmed keys module 214.

Further, the cursor 420 allows the user to replace the position tabs with the pre-programmed keys. The user is able to interact with the cursor 420 through the touch screen display unit (210 shown in FIG. 2). In another preferred embodiment of the present invention, the user is able to replace the pre-programmed key by dragging upto the desired position tab.

FIG. 5 illustrates a screenshot showing of a digital keyboard module 216, an inventory management module 218 and the communication module 220. With reference to FIG. 4, the digital keyboard module 216 displays only the configured 402 pre-programmed keys at the same position where the user replaces the position tabs with the pre-programmed keys.

The inventory management module 218 displays product details received from the scanner (202 shown in FIG. 2). The inventory management module 218 further receives the input instructions corresponding to the product details from the digital keyboard module 216.

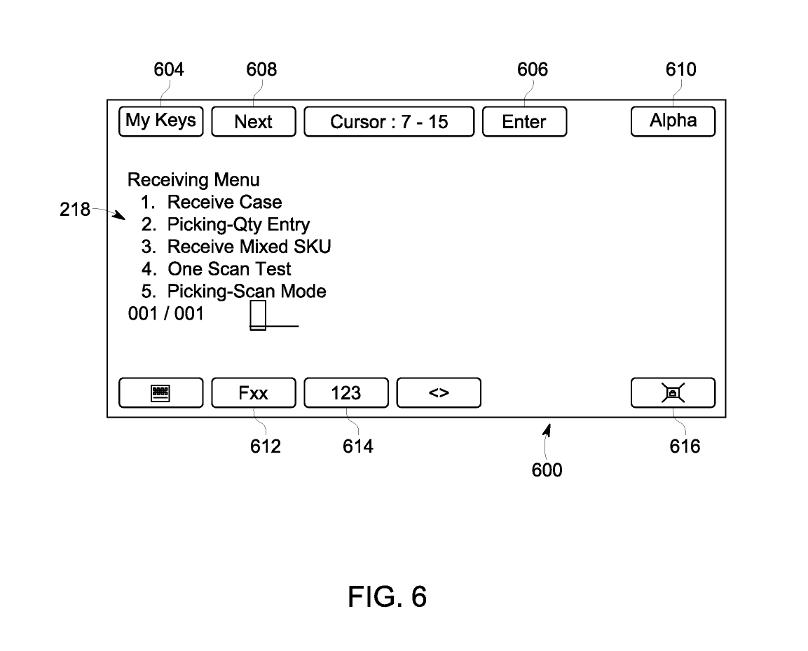

For exemplary purposes, as shown in FIG. 5, the product details are shipment number 502, PO number 504 and Vendor number 506. The product details are explained in detail in conjunction with FIG. 6 of the present invention. The communication module 220 is coupled to the digital keyboard module 216 for sending the product details along with the input instructions through the bi-directional communication unit. In a preferred embodiment of the present invention, the communication module 220 is represented by the pre-programmed key ENTER.

In another preferred embodiment of the present invention, the plurality of modules further includes an image module 502 for displaying a product image 506 corresponding to the scanned product number 506. In a preferred embodiment of the present invention, the digital keyboard module 216 and the product details are superimposed on the product image 506. The product image 506 corresponds to the product in the container, which is scanned by the scanner (202 shown in FIG. 2).

FIG. 6 illustrates a screenshot showing of a dashboard module 600 to display inventory management module 218 and peripheral plurality of modules in accordance with a preferred embodiment of the present invention. The plurality of modules further include my keys module 602, a heuristic module, an enter module 604, a next module 606, and an alpha module 608.

The my keys module 602 displays the configured pre-programmed keys in the digital keyboard module. The heuristic module is coupled to the digital keyboard module to maintain a count of pre-programmed key presses and further automatically configures pre-programmed keys module 602 by optimally displaying the most often used pre-programmed keys.

The optimally displaying in the heuristic module is to identify the most efficient position tabs in the position tab module where the pre-programmed keys may be placed in such a way that it takes the user the least amount of time to press them. The heuristic module works on machine learning to note the repeated keys and then automatically configures in the my keys module 602.

The enter module 604 is coupled to the digital keyboard module for allowing the user to send the input instructions over the communication network. The enter module 604 functions same as the communication module. The next module 608 moves the cursor in five positions forward in the horizontal direction.

The alpha module 610 is coupled to the pre-programmed keys to open alphabet pre-programmed keys in the pre-programmed keys module. For example, on pressing alpha module 610, a keyboard showing all alphabets is open for allowing the user to select to put the input instructions corresponding to the inventory management module 218.

The inventory management module 218 further includes product details like receiving case, picking-Qty Entry, receive mixed SKU, one scan test and picking—scan mode. It would be readily apparent to those skilled in the art that various other types of product details may be envisioned without deviating from the scope of the present invention.

Similarly to the alpha module 610, various modules may be envisioned such as function module 612 to display all function keys in the pre-programmed in the pre-programmed keys module, a numeral module 614 to display all numbers in the pre-programmed keys module, and a zoom module 616 to either zoom in or zoom out the content displayed on the display unit.

The present invention offers various advantages such as decreased training, improved efficiency, and fewer errors. Further, the present invention allows the user to easily operate the pre-programmed keys, as the desired keys are placed on the desired places. Further, the size of the keys is increased, as the same space on the display unit is utilized for lesser desired pre-programmed keys.

These and other changes can be made to the invention in light of the above detailed description. In general, the terms used in the following claims, should not be construed to limit the invention to the specific embodiments disclosed in the specification, unless the above detailed description explicitly defines such terms. Accordingly, the actual scope of the invention encompasses the disclosed embodiments and all equivalent ways of practicing or implementing the invention under the claims.

1. A digital keyboard system for allowing a user to send instructions over a communication network, the digital keyboard system comprising:
a memory unit for storing plurality of modules;
a processing unit coupled to the memory unit to process the stored plurality of modules;
a display unit to display the processed plurality of modules, wherein the plurality of modules comprising:
a pre-programmed keys module displaying pre-programmed keys, wherein the user selects at least one of the pre-programmed keys;
a position tab module coupled to the pre-programmed keys module displays plurality of position tabs as arranged in a keyboard, wherein the user replaces any position tab with any pre-programmed key to create a configuration;
a digital keyboard module displays only the configured pre-programmed keys at the same position where the user replaces the position tabs with the pre-programmed keys, further the digital keyboard module allows the user to input instructions corresponding to the pre-programmed keys; and
a communication module coupled to the digital keyboard module for sending the received input instructions over the communication network.

2. The digital keyboard system according to claim 1 wherein the pre-programmed keys of the pre-programmed keys module are arranged in a scroll bar, further the user scrolls the scroll bar to access the pre-programmed keys.

3. A digital keyboard system communicating with a scanner to receive product details, further the digital keyboard system allows a user to send instructions over a communication network, the digital keyboard system comprising:
a memory unit for storing plurality of modules;
a processing unit coupled to the memory unit to process the stored plurality of modules;
a bi-directional communication unit to receive product details from the scanner; and
a display unit to display the processed plurality of modules, wherein the plurality of modules comprising:
a pre-programmed keys module displaying pre-programmed keys, wherein the user selects at least one of the pre-programmed keys;
a position tab module coupled to the pre-programmed keys module displays plurality of position tabs as arranged in a keyboard, wherein the user replaces any position tab with any pre-programmed key to create a configuration;
a digital keyboard module displays only the configured pre-programmed keys at the same position where the user replaces the position tabs with the pre-programmed keys, further the digital keyboard module allows the user to input instructions corresponding to the pre-programmed keys;
an inventory management module displays product details received from the scanner, the inventory management module further receives the input instructions corresponding to the product details from the digital keyboard module; and
a communication module coupled to the digital keyboard module for sending the product details along with the input instructions through the bi-directional communication unit over the communication network.

4. The digital keyboard system according to claim 3 wherein the product details comprising at least one of: location; SKU; Quantity; and ScanUPC.

5. The digital keyboard system according to claim 3, wherein the plurality of modules further comprising an image module for displaying a product image corresponding to the scanned product number, wherein the digital keyboard module and the product details are superimposed on the product image.

6. The digital keyboard system according to claim 3 wherein the plurality of modules further comprising my keys module to display the configured pre-programmed keys in the digital keyboard module.

7. The digital keyboard system according to claim 3, wherein the plurality of modules further comprising a heuristic module coupled to the digital keyboard module to maintain a count of pre-programmed key presses and further automatically configures the pre-programmed keys module by optimally displaying the most often used pre-programmed keys.

8. The digital keyboard system according to claim 3, wherein the plurality of modules further comprising a cursor module to display a cursor to select pre-programmed keys from the pre-programmed keys module and further the cursor allows the user to replace the position tabs with the pre-programmed keys.

9. The digital keyboard system according to claim 3, wherein the plurality of modules further comprising an enter module coupled to the digital keyboard module for allowing the user to send the input instructions over the communication network.

10. The digital keyboard system according to claim 8, wherein the plurality of modules further comprising a next module to move the cursor five positions forward in the horizontal direction.

11. The digital keyboard system according to claim 3, wherein the plurality of modules further comprising an alpha module coupled to the pre-programmed keys to open alphabet pre-programmed keys.

12. The digital keyboard system according to claim 3, wherein the plurality of modules further comprising a dashboard module to display product details and further allows the user to access various plurality of modules.

13. The digital keyboard system according to claim 3, wherein the plurality of modules further comprising a profile module to allow the user to store plurality of digital keyboard module, wherein each digital keyboard module comprising a different set of pre-programmed keys.
